(19) United States
(12) Patent Application Publication
(10) Pub. No.: US 2006/0242998 A1
(43) Pub. Date: Nov. 2, 2006

(54) Preform consolidation process

(75) Inventor: Arthur I. Shirley, Hillsborough, NJ (US)

Correspondence Address: THE BOC GROUP, INC., 575 MOUNTAIN AVENUE, MURRAY HILL, NJ, 07974-2064, US

(73) Assignee: The BOC Group, Inc.

(21) Appl. No.: 11/118,818

(22) Filed: Apr. 29, 2005

(51) Int. Cl. C03B 37/018

(52) U.S. Cl. 65/427; 65/27

(57) ABSTRACT

The present invention is directed to the problem of gases and other impurities entering a consolidation furnace during the forming of a glass preform used in fiber optic manufacture. Inert gas, such as nitrogen, is directed over the seals of the consolidation furnace during the heating operation to convert the soot body into a consolidation preform. The inert gas will inhibit other gases from entering the consolidation furnace as well as inhibit the entry of contaminants into the furnace. By inhibiting the entry of both additional gases and impurities, less helium needs to be employed in the consolidation process.

### BACKGROUND OF THE INVENTION

The present invention provides for a process for improving efficiency of the preform consolidation process in fiber optic manufacturing operations by inhibiting impurities that are introduced into the consolidation furnace. This is achieved by directing streams of inert gas at the seals in the consolidation furnace. The inert gas streams will inhibit air ingress into the furnace resulting in inhibiting the introduction of impurities into the consolidation furnace. This will reduce the overall demand for helium as employed in the preform consolidation process.

Glass preforms that are used to make optical fiber can be fabricated using the vertical axis deposition (VAD) or outside vapor deposition (OVD) methods. After the deposition step, the preform exists as a “soot” body of a porous matrix of silica particles that has a milky, opaque appearance. The soot body must be dried and consolidated to remove internal voidage and moisture, resulting in a clear glass rod which will ultimately be drawn into the optical fiber.

In some processes only the core and cladding are deposited and then consolidated. After consolidation, additional cladding may be added as an overcladding step to build the preform to the desired diameter before drawing. Depending on the cladding process, additional soot may be deposited on the outside of the consolidated core, requiring an additional consolidation step.

During consolidation, the soot body is placed inside a furnace typically consisting of a quartz muffle. The furnace is heated to above the sintering temperature of the glass, usually above ˜2100° C., and helium gas is fed through the muffle tube to aid in heat transfer to the soot. The helium also serves to sweep away moisture and other impurities released by the soot as it heats and consolidates.

At some point in the process of consolidation, a gas mixture of helium and chlorine is passed through the porous glass to remove impurities and reduce the water content of the glass to a parts per billion level. This step is particularly critical in the production of preforms used to make low-water peak fiber (LWPF). The dehydration gases used in the consolidation process include chlorine and chlorine-containing compounds such as SOCl₂ and CCl₄.

Large amounts of helium are consumed during the typical consolidation process and the helium is typically captured, treated and vented. This can cause higher costs to the fiber optic manufacturer because helium is relatively expensive. The present invention is directed to providing a solution to the problem of helium loss during the consolidation process, as well as inhibiting the introduction of impurities into the furnace.

### SUMMARY OF THE INVENTION

The present invention is directed to an improved method of forming a glass perform in a consolidation furnace which comprises inhibiting the amount of impurities entering the consolidation furnace.

In another embodiment, the present invention is directed to a method for reducing the demand for gas in a consolidation furnace during the consolidation of a soot body into a glass preform comprising directing an inert gas stream at the seals of the consolidation furnace.

In a further embodiment of the present invention, a method for reducing the ingress of impurities into a consolidation furnace during the consolidation of a soot body into a glass preform comprising directing an inert gas stream at the seals of the consolidation furnace is described.

The advantages offered by the invention as described include the use of higher purity helium and chlorine further reducing the amount of impurities present in the consolidation furnace and less impurities that must be removed from the furnace. Less moisture and oxygen enter the consolidation furnace thereby speeding drying time and producing a purer preform. The inhibition of gas leaks around the seals allows for a reduction in helium flow in the initial stages of consolidation to prevent heat loss thereby speeding the heating process.

### DETAILED DESCRIPTION OF THE INVENTION

The present invention is directed to the problem of gas and impurities ingress into a consolidation furnace during the manufacture of an optical fiber preform.

The consolidation of a preform for use in fiber optic drawing operations requires that a soot body be heated in a consolidation furnace to dry and be consolidated to remove moisture and internal voidages.

The consolidation process will utilize a number of gases in order to purge the furnace, add ingredients to the soot body and to aid in vitrification and drying. As such the exhaust gas mixture exiting the consolidation furnace will include helium, chlorine, hydrochloric acid, nitrogen, oxygen, water and occasionally fluorine-containing gases.

The consolidation process begins with the lowering of the soot body into the furnace. The furnace is typically a quartz muffle which can withstand the temperatures necessary to heat and dry the soot body. The quartz muffle will typically have a gas input line and a gas output line with seals around these lines. Further, the top of the quartz muffle is removable in order to lower the soot body into the muffle and the bottom portion will also be jointed such that seals are necessary around the top and the bottom of the quartz muffle.

Because of the high temperatures (˜2100° C.) that the quartz muffle is subject to, the seals must allow for expansion which can result in moisture and air entering the furnace. These contaminants will cause for a inefficient drying process as well as problems with the preform.

To understand the benefit of the present invention, one must look at the chemical equilibrium that governs the drying process. The reduction of moisture (hydroxyl groups) in silica is generally held to result from the competing reactions
H₂O (g)+Cl₂ (g)=2HCl (g)+½ O₂ (g) (1),
and
H₂O (g)+[Si—O-Sl]=2[Si—OH] (2).

As Reactions 1 and 2 proceed an equilibrium develops that can be described by

$${C}_{SiOH} α \frac{{[ {P}_{HCI} ] [ {P}_{O 2} ]}^{1 / 4}}{{[ {P}_{CI 2} ]}^{1 / 2}} . \qquad ( 3 )$$

As the drying step proceeds the equilibrium is controlled by the conversion of residual moisture in the drying gas, not in the soot, and Equation (3) can be rewritten

$${C}_{SiOH} α \frac{{{[ {P}_{H 2 O} ]}^{1 / 2} [ {P}_{O 2} ]}^{1 / 4}}{{[ {P}_{CI 2} ]}^{1 / 2}} , \qquad ( 4 )$$

where Pᵢ is the partial pressure of constituent “i” in the vapor phase.

Equation (4) highlights some important requirements for any process to make ultra-dry silica. First, the chlorine concentration in the drying atmosphere should be quite high, although not higher than allowed by the critical diameter of the pores in the soot body (5). Secondly, the concentrations of moisture and oxygen in the drying atmosphere must be extremely low.

The present invention addresses this problem of leakage around the seals of the quartz muffle by directing jets or curtains of inert gas from a manifold over the seals. The inert gas may be selected from the group of nitrogen, argon, helium, neon, and carbon dioxide with nitrogen preferred.

The inert gas may be heated prior to it being directed towards the seals of the quartz muffle. The inert gas may be continuously directed at the seals of the quartz muffle as the muffle will remain heated during the process of inserting, heating and removing the soot body.

The inert gas is directed at the seals at a rate sufficient to inhibit loss of helium and ingress of impurities from the consolidation furnace.

The inert gas is directed at the seals at a rate of about 1 to about 100 standard liters per minute.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit of the present invention.

Having thus described the invention, what I claim is:

1. An improved method of forming a glass preform in a consolidation furnace, the improvement comprising reducing the amount of impurities entering said consolidation furnace.

2. The method as claimed in claim 1 comprising directing an inert gas stream at the seals of said consolidation furnace.

3. The method as claimed in claim 1 wherein said consolidation furnace comprises a quartz muzzle.

4. The method as claimed in claim 1 wherein said consolidation furnace has an inlet gas line and an outlet gas line.

5. The method as claimed in claim 1 wherein said seals are at the top and bottom of said consolidation furnace.

6. The method as claimed in claim 4 wherein said seals are around said inlet gas line and said outlet gas line.

7. The method as claimed in claim 1 wherein said inert gas is selected from the group consisting of nitrogen, argon, helium, neon and carbon dioxide.

8. The method as claimed in claim 7 wherein said inert gas is nitrogen.

9. The method as claimed in claim 1 wherein said inert gas is dry.

10. The method as claimed in claim 1 wherein said inert gas is warmed before being directed towards said seals.

11. The method as claimed in claim 1 wherein said inert gas is directed at said seals at a rate sufficient to inhibit loss of helium from said consolidation furnace.

12. The method as claimed in claim 11 wherein said inert gas is directed at said seals at a rate of about 1 to about 100 standard liters per minute.

13. A method for reducing the loss of gases in a consolidation furnace during the consolidation of a soot body into a glass preform comprising directing an inert gas stream at the seals of said consolidation furnace.

14. The method as claimed in claim 13 wherein said consolidation furnace comprises a quartz muzzle.

15. The method as claimed in claim 13 wherein said consolidation furnace has an inlet gas line and an outlet gas line.

16. The method as claimed in claim 13 wherein said seals are at the top and bottom of said consolidation furnace.

17. The method as claimed in claim 16 wherein said seals are around said inlet gas line and said outlet gas line.

18. The method as claimed in claim 13 wherein said inert gas is selected from the group consisting of nitrogen, argon, helium, neon and carbon dioxide.

19. The method as claimed in claim 18 wherein said inert gas is nitrogen.

20. The method as claimed in claim 13 wherein said inert gas is dry.

21. The method as claimed in claim 13 wherein said inert gas is warmed before being directed towards said seals.

22. The method as claimed in claim 13 wherein said inert gas is directed at said seals at a rate sufficient to inhibit loss of gases from said consolidation furnace.

24. The method as claimed in claim 22 wherein said inert gas is directed at said seals at a rate of about 1 to about 100 standard liters per minute.

24. The method as claimed in claim 13 wherein said gases are selected from the group consisting of helium, chlorine and fluorine.

25. A method for reducing the ingress of impurities into a consolidation furnace during the consolidation of a soot body into a glass preform comprising directing an inert gas stream at the seals of said consolidation furnace.

26. The method as claimed in claim 25 wherein said consolidation furnace comprises a quartz muzzle.

27. The method as claimed in claim 25 wherein said consolidation furnace has an inlet gas line and an outlet gas line.

28. The method as claimed in claim 25 wherein said seals are at the top and bottom of said consolidation furnace.

29. The method as claimed in claim 28 wherein said seals are around said inlet gas line and said outlet gas line.

30. The method as claimed in claim 25 wherein said inert gas is selected from the group consisting of nitrogen, argon, and helium.

31. The method as claimed in claim 30 wherein said inert gas is nitrogen.

32. The method as claimed in claim 25 wherein said inert gas is dry.

33. The method as claimed in claim 25 wherein said inert gas is warmed before being directed towards said seals.

34. The method as claimed in claim 25 wherein said inert gas is directed at said seals at a rate sufficient to inhibit ingress of impurities into said consolidation furnace.

35. The method as claimed in claim 34 wherein said inert gas is directed at said seals at a rate of about 1 to about 100 standard liters per minute.
